(19) United States
(12) Patent Application Publication
(10) Pub. No.: US 2004/0062415 A1
(43) Pub. Date: Apr. 1, 2004

(54) Voice coil bobbin

(75) Inventor: Takashi Suzuki, Yamagata-ken (JP)

Correspondence Address: ARENT FOX KINTNER PLOTKIN & KAHN, PLLC, Suite 600, 1050 Connecticut Avenue, N.W., Washington, DC, 20036-5339, US

(73) Assignees: Pioneer Corporation; Tohoku Pioneer Corporation

(21) Appl. No.: 10/665,208

(22) Filed: Sep. 22, 2003

(30) Foreign Application Priority Data
Sep. 30, 2002 (JP) 2002-284684

(51) Int. Cl. H04R 1/00; H04R 9/06; H04R 11/02

(52) U.S. Cl. 381/407; 381/400

(57) ABSTRACT

A voice coil bobbin comprises a cloth material woven from longitudinal and lateral fibers, and transmits driving force caused by a voice coil wound thereon to a diaphragm. The longitudinal or lateral fibers are obliquely oriented with respect to the direction of the driving force. Thus, rigidity and mechanical strength required for the voice coil bobbin are ensured with reduced weight and cost.

### BACKGROUND OF THE INVENTION

1.Field of the Invention

The present invention relates to a voice coil bobbin.

The present application claims priority from Japanese Patent Application No. 2002-284684, the disclosure of which is incorporated herein by reference in its entirety.

2.Description of the Related Art

FIG. 1 shows a sectional view of the structure of a loudspeaker. It should be noted that in FIG. 1 only half of a longitudinal section is shown. As shown in FIG. 1, an annular magnetic circuit 6 is formed at a bottom part of an annular frame 2. The magnetic circuit 6 includes a center pole 3, a magnet 4, and a top plate 5. The upper part of the outer periphery of the center pole 3 and the inner surface of the top plate 5 define an annular gap 7. High density of magnetic flux can be formed in the gap 7, where a voice coil bobbin 8 is held in an axially movable fashion.

The voice coil bobbin 8 has a cylindrical shape. A voice coil 9 is wound up on the bottom part of the outer periphery of the voice coil bobbin 8. A diaphragm 10 and a suspension 11 are fixed to the voice coil bobbin 8 at respective ends. The diaphragm 10 is attached to the frame 2 via an edge 12, and the suspension 11 is directly attached to the frame 2 at respective other ends, so as to oscillate freely.

In the voice coil bobbin 8 with the aforementioned structure, required is a function for transmitting driving force, generated at the voice coil 9 by sound current, to the diaphragm 10 with high fidelity. The requirement entails reduced weight for the sake of efficiency, and greater rigidity in order to prevent deformation to be caused by oscillation. Paper is often utilized as a material measuring up to these requirements because of its low density, appropriate rigidity, and inexpensiveness, while foil such as aluminum or duralumin foil, or plastic film such as polyimide film is otherwise utilized.

A loudspeaker accepting intense input has a problem, such that thermal expansion of the voice coil bobbin 8 caused by Joule heat harms the adhesion between the voice coil 9 and the voice coil bobbin 8, thereby stripping the voice coil 9 and the voice coil bobbin 8 from each other. A conventional art to solve the problem, for instance, as disclosed in JP H07-75197 A, has been proposed. The art utilizes a textile woven from fibers, which is impregnated with a binding resin including a silicon resin.

The voice coil bobbin woven from fibers as disclosed above, orients the longitudinal fibers of the textile along the axis of the bobbin, while the lateral fibers of the textile are woven at right angles to the longitudinal fibers. That is, rectangular strips of the textile cut along the weaving direction, are formed into a cylindrical shape by coming together to obtain the voice coil bobbin.

The voice coil is wound up on the conventional voice coil bobbin along the lateral fibers. The voice coil transforms the sound current passing therethrough into driving force along the axis of the bobbin. Thus, the conventional voice coil bobbin has a following structure. That is, the driving force caused by the winding part of the voice coil concentrates on the longitudinal fibers along the axis of the bobbin while the driving force is not applied directly to the lateral fibers oriented at right angles to the longitudinal fibers.

Adoption of longitudinal fibers made of high-strength material, against the concentration of the driving force, may increase the weight. This adoption may cause the following problems, that is, disturb high-fidelity transmission of the oscillation caused by the voice coil to the diaphragm, furthermore increasing the cost. Continuous use with intense input under the aforementioned condition may distort the voice coil bobbin, resulting in buckling of the voice coil bobbin itself. According to this failure, sufficient output cannot be attained, thereby disabling the operation of the loudspeaker.

### SUMMARY OF THE INVENTION

It is an object of the present invention to respond the above situations and to solve the problems. That is, it is an object of the present invention to ensure the rigidity and mechanical strength required for a voice coil bobbin with reduced weight and cost.

In order to accomplish the aforementioned and other objects, according to a first aspect of the present invention, there is provided a voice coil bobbin for transmitting driving force caused by a voice coil wound thereon to a diaphragm, comprising a cloth material woven from longitudinal and lateral fibers, wherein the longitudinal and lateral fibers are obliquely oriented with respect to a direction of the driving force.

### BRIEF DESCRIPTION OF DRAWINGS

These and other objects and advantages of the present invention will become clear from the following description with reference to the accompanying drawings, wherein:

FIG. 1 illustrates a conventional loudspeaker; and

FIG. 2 illustrates a voice coil bobbin according to an embodiment of the present invention.

### DESCRIPTION OF THE PREFERRED EMBODIMENT

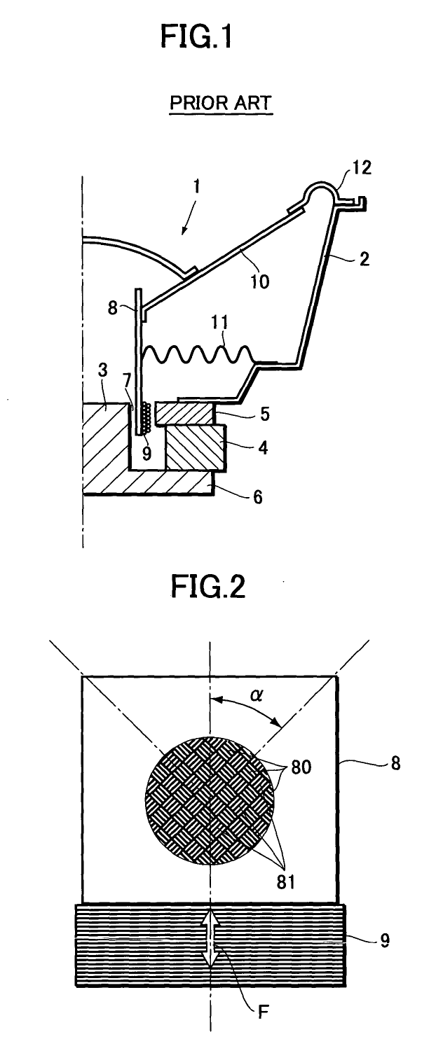

A preferred embodiment of the present invention, presently considered to be the best mode, is hereinafter described in detail with reference to the accompanying drawings. FIG. 2 illustrates a voice coil bobbin according to an embodiment of the present invention. It should be noted that the voice coil bobbin concerned, for example, may be utilized as a voice coil bobbin 8 in the loudspeaker shown in FIG. 1.

According to an embodiment of the present invention, first, the voice coil bobbin 8 is formed of a cloth material. The cloth material comprises longitudinal fibers 80 and lateral fibers 81 woven together thereinto. The voice coil bobbin 8 receives a driving force F from a voice coil 9 wound on the periphery of the bobbin 8, to transmit the driving force F to the diaphragm 10 (not shown in FIG. 2). The longitudinal or lateral fibers of the voice coil bobbin 8 are oriented along an oblique direction with respect to the direction of the driving force F. This orientation distributes the driving force F by the voice coil 9 and the self-weight of the voice coil 9 to both of the longitudinal and lateral fibers 80 and 81. The distribution of the force substantially increases the strength of the voice coil bobbin 8 without increasing the strength of the fibers themselves, thereby ensuring the mechanical strength required for the voice coil bobbin without any influence on the weight or the cost. The oblique orientation of the longitudinal or lateral fibers with respect to the axis of the voice coil bobbin 8, increases the radial rigidity of the cylindrical voice coil bobbin 8, thereby preventing the voice coil 9 from being deformed by partial oscillation of the diaphragm.

Secondly, the voice coil bobbin 8 may be configured such that the oblique orientation angle a of the longitudinal fibers 80 or the lateral fibers 81 with respect to the direction of the driving force F is 45 degrees. The first feature described above, when further measuring up to this second feature, uniformly distributes the load to the longitudinal and lateral fibers. Thus, this configuration not only ensures the mechanical strength required for the voice coil bobbin without any influence on the weight or the cost, but also increases the radial rigidity of the cylindrical voice coil bobbin, thereby preventing the voice coil from being deformed by partial oscillation of the diaphragm.

Thirdly, the aforementioned voice coil bobbin 8 further has a third feature characterized in that the longitudinal or lateral fibers 80 or 81 may be made of glass fibers. The third feature, in addition to the features described above, increases heat resistance because of the thermal property of the glass fibers, and prevents excessive thermal expansion or thermal failure even with application of Joule heat caused by intense input of the sound current into the voice coil 9.

Fourthly, a loudspeaker may be configured such that the aforementioned voice coil 9 may be placed in the gap of the magnetic circuit and the aforementioned voice coil bobbin 8 may be provided as shown in FIG. 1. Thus, this loudspeaker adopts the voice coil bobbin with higher mechanical strength and rigidity and heat stability, thereby ensuring reliable transmission of the driving force concerning the voice coil to the diaphragm even in the case of intense input, also attaining reliable sound output, furthermore increasing durability to intense input. It should be noted that the oblique orientation angle a is not limited to 45 degrees. Instead, the angle may be appropriately determined according to the characteristics of the voice coil bobbin itself and that of the loudspeaker with the same bobbin.

A process for manufacturing a voice coil bobbin 8 having glass fibers is now described as a working example of the present invention. A textile, whose longitudinal and lateral fibers 80 and 81 are glass fibers, is utilized as a base material. First, the textile is cut into a rectangular strip, with the longitudinal and lateral fibers 80 and 81 oriented obliquely with respect to the edges of the strip. Then, the textile is impregnated with a resin, and subsequently formed into a cylindrical shape. Thus, a cylindrical bobbin 8 is obtained with the longitudinal and lateral fibers 80 and 81 oriented obliquely with respect to the axis of the cylindrical bobbin 8. Then, a voice coil 9 is wound on the bottom part of the outer periphery of the voice coil bobbin 8, thereby obtaining a voice coil bobbin assembly.

Since the embodiments of the present invention are configured as described above, the rigidity and mechanical strength required for the voice coil bobbin can be ensured with reduced weight and cost. Adoption of such a voice coil bobbin attains reliable sound output even in the case of intense input, and provides a loudspeaker of high durability.

While the presently preferred embodiments of the present invention have been shown and described, it is to be understood that these disclosures are for the purpose of illustration and that various changes and modifications may be made without departing from the scope of the invention as set forth in the appended claims.

What is claimed is:

1. A voice coil bobbin for transmitting driving force caused by a voice coil wound thereon to a diaphragm, comprising:
a cloth material woven from longitudinal and lateral fibers,
wherein the longitudinal and lateral fibers are obliquely oriented with respect to a direction of the driving force.

2. The voice coil bobbin according to claim 1, wherein
an oblique orientation angle of the longitudinal or lateral fibers to the direction of the driving force is 45 degrees.

3. The voice coil bobbin according to claim 1, wherein
the longitudinal or lateral fibers are glass fibers.

4. A loudspeaker, comprising the voice coil bobbin according to claim 1-3, wherein the voice coil is placed in a gap of a magnetic circuit.
